(19) United States
(12) Patent Application Publication
(10) Pub. No.: US 2025/0068193 A1
(43) Pub. Date: Feb. 27, 2025

(54) Dual Radius Ball Valve Component

(71) Applicant: Illinois Tool Works Inc., Glenview, IL (US)

(72) Inventors: Christopher A. Carns, Hicksville, OH (US); Nathan C. Osmun, Edgerton, OH (US)

(21) Appl. No.: 18/811,921

(22) Filed: Aug. 22, 2024

Related U.S. Application Data
(60) Provisional application No. 63/534,135, filed on Aug. 23, 2023.

(51) Int. Cl. G05D 23/02; F16K 5/06; F16K 31/00

(52) U.S. Cl. CPC G05D 23/028; F16K 5/0605; F16K 5/0647; F16K 31/002

(57) ABSTRACT

Disclosed is a thermostatic valve assembly having a valve body with a chamber, an inlet port, a first output port, and a second output port. The thermostatic assembly includes a wax element, a ball valve component with a drive pin, and a plunger with a drive opening to engage the drive pin. The ball valve component is rotatably secured within the chamber and transitions between a first rotational position when the plunger is in the first linear position and a second rotational position when the plunger is in the second linear position. The ball valve component features a body portion that includes a first spherical portion, defined by a radius extending from the axis to the exterior surface of the first spherical portion, and a second spherical portion with a second radius extending from the axis to the exterior surface of the second spherical portion.

### CROSS-REFERENCE

The present application claims priority to U.S. Provisional Patent Application No. 63/534,135, filed Aug. 23, 2023, and entitled “Dual Sphere Ball” which is hereby incorporated by reference in its entirety.

### BACKGROUND

This disclosure relates to a thermostatic valve assembly used to control the flow of fluids, such as water, oil, or coolant, in response to temperature changes. Thermostatic valves are utilized in various applications to manage fluid flow based on temperature fluctuations. One common type of thermostatic valve employs a wax element that expands or contracts with temperature changes to regulate fluid flow.

Thermostatic valves and ball valve components are used in many applications to control fluid flow. Traditional systems often require manual intervention or rely on complex electronic controls to respond to temperature variations. For example, internal combustion engines typically include a cooling circuit that allows coolant, such as antifreeze or water, to flow through a radiator.

The present disclosure seeks to provide an efficient, automatic solution by integrating a thermostatic wax element with a ball valve component mechanism.

### SUMMARY

The present disclosure relates generally to an improved ball valve component, substantially as illustrated by and described in connection with at least one of the figures, as set forth more completely in the claims. In an example, the present disclosure relates generally to an improved ball valve component with improved characteristics for a thermostatic valve assembly.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic diagram of an example internal combustion engine cooling system according to aspects of this disclosure.

FIG. 2a illustrates a top plan view of the valve assembly in accordance with aspects of this disclosure.

FIG. 2b illustrates a first isometric view of the valve assembly.

FIG. 2c illustrates a first isometric cross-sectional view of the valve assembly, taken along cutline A-A in FIG. 2a.

FIG. 2d illustrates a second isometric view of the valve assembly.

FIG. 2e illustrates a second isometric cross-sectional view of the valve assembly, taken along cutline B-B in FIG. 2a.

FIG. 2f illustrates an isometric view of a thermostatic assembly within the valve assembly.

FIG. 2g illustrates an isometric cross-sectional view of the thermostatic assembly, taken along cutline C-C in FIG. 2f.

FIGS. 2h and 2i illustrate side elevation cross-sectional views of the valve assembly in respectively, a bypass open position and a bypass closed position.

FIGS. 2j and 2k illustrate a side elevation and perspective views of the valve assembly with portions of the valve body omitted.

FIG. 3a illustrates a perspective view of the ball valve component in accordance with aspects of this disclosure.

FIGS. 3b and 3c respectively illustrate first and second side elevation views of the ball valve component.

FIGS. 3d and 3e respectively illustrate front and rear elevation views of the ball valve component.

FIGS. 3f and 3g respectively illustrate top and bottom plan views of the ball valve component.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Advantages of thermostatic wax valve actuators include reliability, precision, and self-contained operation. With few moving parts and a robust design, thermostatic wax valve actuators offer high reliability and a long service life. The ability of thermostatic wax valve actuators to provide precise temperature control stems from the known expansion properties of a given wax. Moreover, thermostatic wax valve actuators do not require an external power source, operating instead based on temperature changes, which simplifies their integration into various systems. However, there are some limitations to existing thermostatic wax valve actuators, such as their slower response times compared to electronic actuators and the operational temperature range is restricted to the melting and solidifying points of the wax used in the element.

Disclosed is a thermostatic valve assembly for an internal combustion engine cooling system. A thermostatic wax valve actuator is configured to regulate the flow of fluids, such as coolant in an engine, by responding to temperature variations. The actuator comprises several primary components, including a wax element, a plunger, housing, and a return spring. The present disclosure relates to thermostatic wax valves and, more specifically, to a thermostatic wax valve assembly comprising a ball valve component that rotates in response to linear movement of a plunger, which is driven by changes in wax volume due to temperature variations.

Also disclosed is a ball valve component with a dual-sphere ball design to accommodate advanced sealing mechanism of the ball valve component to significantly improve the thermostatic valve assembly's performance. By reducing coolant leakage through the bypass seal and improving fluid flow control, the disclosure enhances the efficiency of the internal combustion engine cooling system. The precise rotational control provided by the interaction between the ball valve component and the plunger ensures accurate fluid flow management in response to temperature changes.

The dual-radius design also enables the ball valve component to maintain a compact size while integrating the necessary seals and flow control features. This design improvement allows the thermostatic valve assembly to operate effectively within the space constraints of modern engine cooling systems, without sacrificing performance.

In one example, a thermostatic valve assembly comprises: a valve body having a chamber; and a thermostatic assembly comprising a wax element, a ball valve component having a drive pin, and a plunger having a drive opening that is configured to receive the drive pin, wherein the plunger is connected to the wax element and slideably secured within the chamber and configured to move between a first linear position and a second linear position, wherein the ball valve component is rotatably secured within the chamber and configured to move between a first rotational position about an axis when the plunger is in the first linear position and a second rotational position when the plunger is in the second linear position, and wherein the ball valve component comprises a body portion with a cavity configured to direct fluid flow, the body portion defining a first spherical portion having a first radius defined between the axis and an exterior surface of the first spherical portion, and a second spherical portion having a second radius defined between the axis and an exterior surface of the second spherical portion.

In another example, a thermostatic assembly for use in a thermostatic valve assembly having a chamber comprises: a wax element; a ball valve component having a drive pin; and a plunger having a drive opening that is configured to receive the drive pin, wherein the plunger is connected to the wax element and slideably secured within the chamber and configured to move between a first linear position and a second linear position, wherein the ball valve component is rotatably secured within the chamber about the axis and configured to move between a first rotational position when the plunger is in the first linear position and a second rotational position when the plunger is in the second linear position, and wherein the ball valve component comprises a body portion including a first spherical portion having a first radius defined between the axis and an exterior surface of the first spherical portion, and a second spherical portion having a second radius defined between the axis and an exterior surface of the second spherical portion.

In another example, a ball valve component for use in a thermostatic assembly having a wax element and a plunger having a drive opening comprises: a drive pin configured to engage the drive opening; a pair of pivot shafts; and a body portion configured to rotate about an axis via a pair of pivot shafts to direct fluid flow, wherein the body portion comprises a first spherical portion having a first radius defined between the axis and an exterior surface of the first spherical portion, and a second spherical portion having a second radius defined between the axis and an exterior surface of the second spherical portion.

In some examples, the second radius is greater than the first radius.

In some examples, the ball valve component is rotatably mounted in the valve body via a pair of pivot shafts.

In some examples, the ball valve component is rotatably secured within the chamber between a first seal and a second seal.

In some examples, each of the first seal and the second seal is a polytetrafluoroethylene (PTFE) seal.

In some examples, the body portion defines a transition portion between the first spherical portion and the second spherical portion.

In some examples, the transition portion comprises a sloped region or a planar region.

In some examples, the transition portion comprises a sloped region and a planar region.

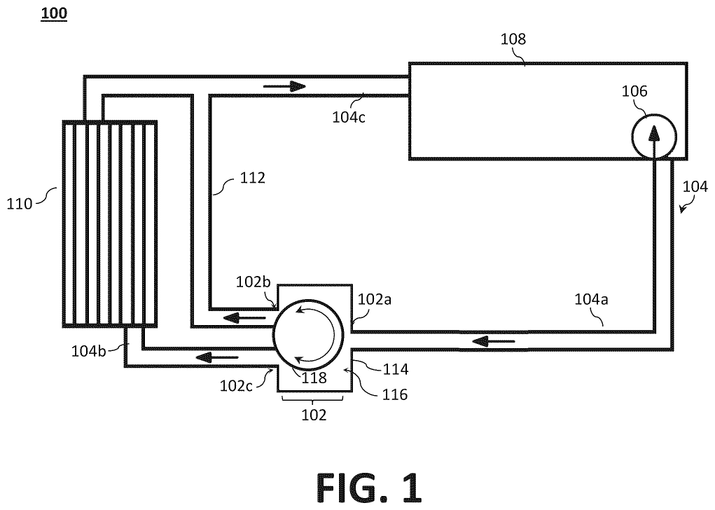

FIG. 1a illustrates a schematic diagram of an internal combustion engine cooling system 100. As shown, the internal combustion engine cooling system 100 includes a cooling circuit 104 operatively connected to a coolant pump 106 of the internal combustion engine 108. The coolant pump 106 can be, for example, a water pump or an antifreeze pump. The cooling circuit 104 includes a radiator 110, a thermostatic valve assembly 102, and one or more fluid conduits.

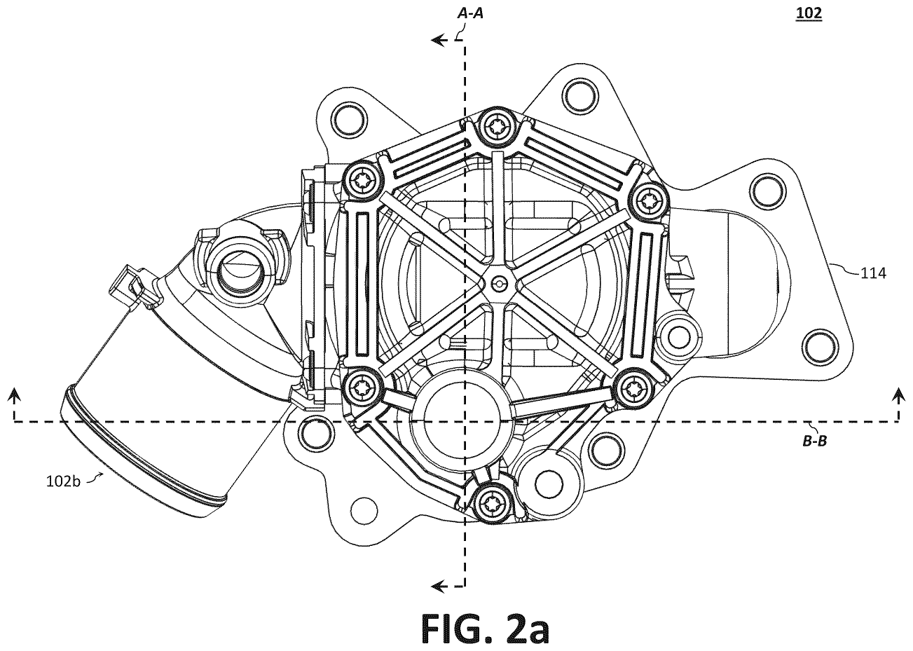

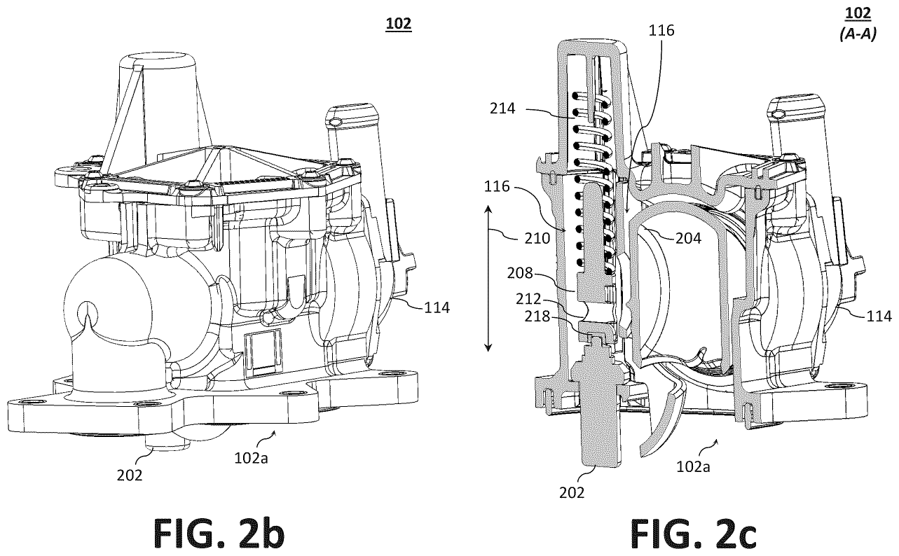

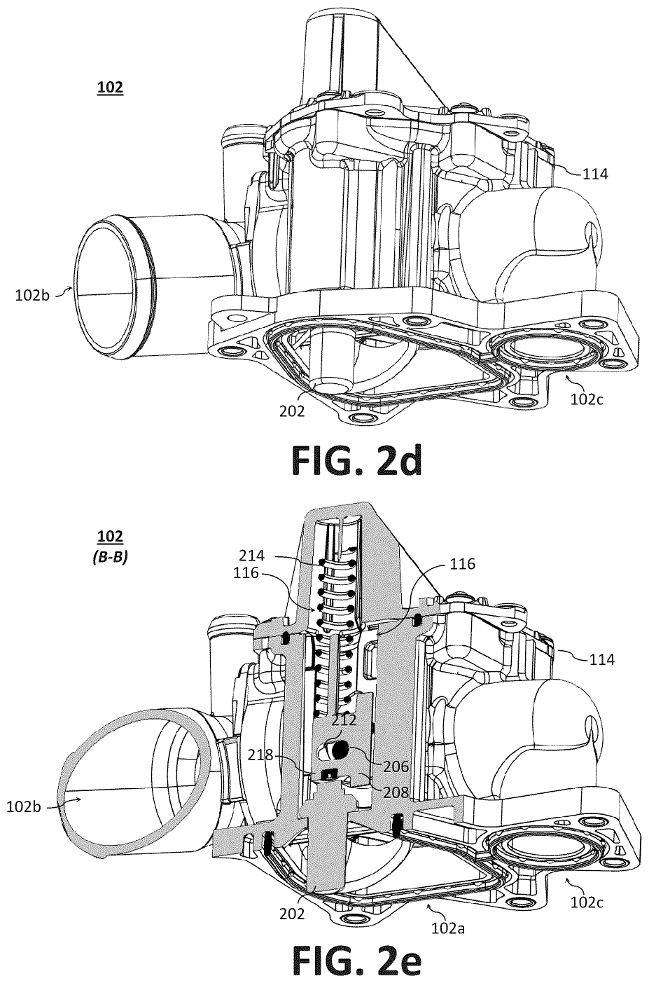

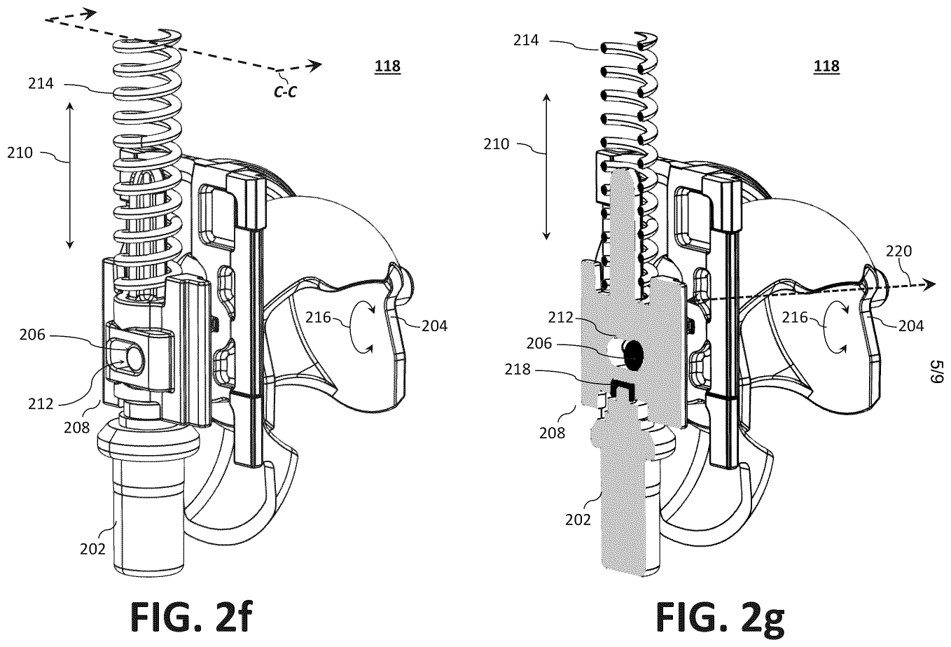

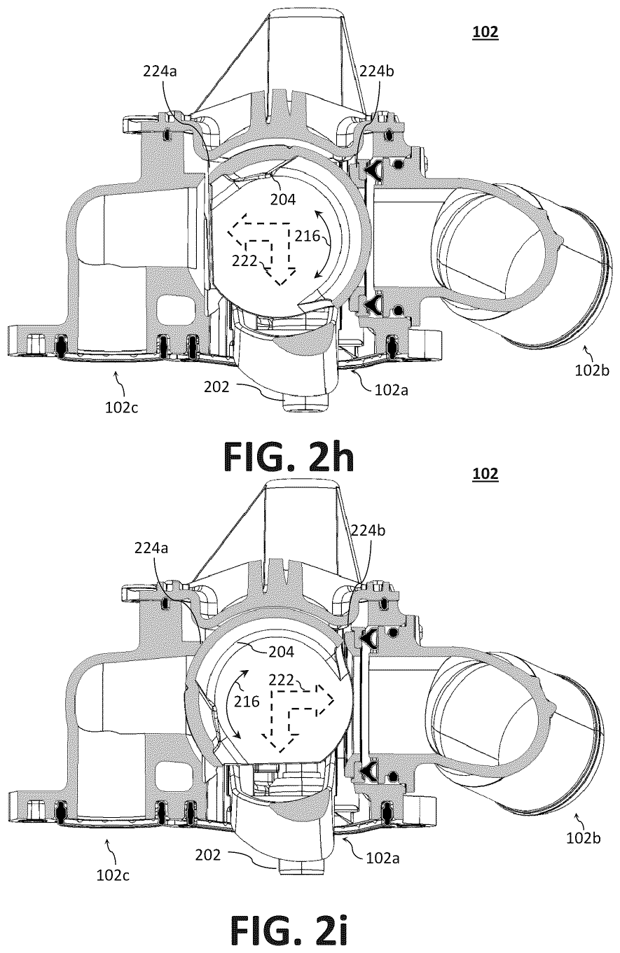

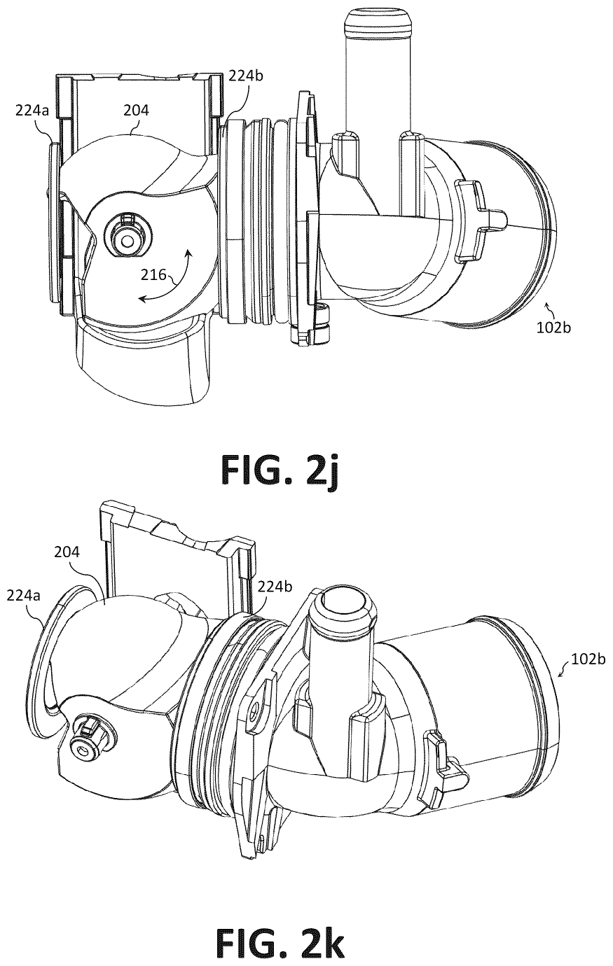

The thermostatic valve assembly 102 is configured to regulate the flow of coolant through the cooling circuit 104, based on factors such as the operational status or temperature of the internal combustion engine 108 or system. As detailed in FIGS. 2a through 2g, the thermostatic valve assembly 102 may incorporate a thermostatic wax element, a plunger, and a ball valve component into a unified assembly. This integration allows for efficient and automatic control of fluid flow in response to temperature variations.

As depicted, the internal combustion engine 108 is in fluid communication with the radiator 110 and the thermostatic valve assembly 102 via a network of fluid conduits. These conduits include a bypass conduit 112 that channels coolant from the thermostatic valve assembly 102 back to the engine 108, bypassing the radiator 110 when necessary. The system also includes a first conduit 104a that directs coolant from the engine 108 to the thermostatic valve assembly 102, a second conduit 104b that sends coolant from the thermostatic valve assembly 102 to the radiator 110, and a third conduit 104c that returns coolant to the engine 108, either from the radiator 110 or the bypass conduit 112, depending on the position of the thermostatic valve assembly 102. The bypass conduit 112 effectively shunts the cooling circuit 104, particularly when the engine is cold (e.g., at a low temperature), allowing for optimal thermal management.

FIG. 2a illustrates a top plan view of the thermostatic valve assembly 102 in accordance with aspects of this disclosure. FIG. 2b illustrates a first isometric view of the thermostatic valve assembly 102, while FIG. 2c illustrates a first isometric cross-sectional view of the thermostatic valve assembly 102, taken along cutline A-A in FIG. 2a. FIG. 2d illustrates a second isometric view of the thermostatic valve assembly 102, while FIG. 2e illustrates a second isometric cross-sectional view of the thermostatic valve assembly 102, taken along cutline B-B in FIG. 2a. FIG. 2f illustrates an isometric view of a thermostatic assembly 118 within the thermostatic valve assembly 102, while FIG. 2g illustrates an isometric cross-sectional view of the thermostatic assembly 118, taken along cutline C-C in FIG. 2f. FIGS. 2h and 2i illustrate a side elevation cross-sectional views of the valve assembly 102 in respectively, a bypass open position and a bypass closed position, while FIGS. 2j and 2k illustrate a side elevation and perspective views of the valve assembly 102 with portions of the valve body 114 omitted.

The thermostatic valve assembly 102 includes a valve body 114 that defines a chamber 116, along with an inlet port 102a configured to fluidly couple with the first conduit 104a, a radiator output port 102c fluidly coupled with the second conduit 104b, and a bypass output port 102b fluidly coupled with the bypass conduit 112. The valve body 114 houses the ball valve component 204, drive pin 206, plunger 208, and wax element 202. The valve body 114 aligns the fluid inlet and outlet ports with the passageways of the ball valve component 204 (e.g., the first opening 232a and the second opening 232b), allowing the ball valve to direct, redirect, or block fluid flow between the ports. These ports include the inlet port 102a, bypass output port 102b, and radiator output port 102c.

The thermostatic valve assembly 102 also includes multiple components that form the thermostatic assembly 118, which controls fluid flow between the inlet port 102a, bypass output port 102b, and radiator output port 102c. The thermostatic assembly 118 comprises a plunger 208, wax element 202, and ball valve component 204. The assembly incorporates both fixed elements (e.g., the wax element 202) and movable elements (e.g., the ball valve component 204 and plunger 208).

The plunger 208 is configured to move linearly, as indicated by arrow 210. It is operatively coupled to the ball valve component 204 via the drive pin 206 and the drive opening 212, so that the linear motion of the plunger 208 causes the ball valve component 204 to rotate around axis 220 (as shown by arrow 216). The plunger 208 is driven by the wax element 202, which expands and contracts with temperature changes. A return spring 214 aids in returning the plunger 208 to its original position as the wax cools and contracts. The plunger 208 converts the wax element's linear expansion and contraction into the rotational motion needed to operate the ball valve component 204, ensuring precise temperature-based control of fluid flow.

The wax element 202, enclosed in a housing, expands and contracts based on temperature changes. It contains a thermally expansive wax that significantly expands when heated and contracts as it cools. This expansion or contraction drives the movement of the plunger 208.

When the temperature increases, the wax in the element melts and expands, pushing the plunger 208 outward. This linear motion opens the valve, allowing coolant or other fluids to flow through the radiator 110 (or a similar heat exchanger) to regulate the system's temperature. When the temperature drops, the wax solidifies and contracts, and the return spring 214 helps pull the plunger 208 back, closing or reversing the valve's operation.

In this example, the plunger 208 moves between a first and second linear position within the chamber 116, driven by the wax element 202. This movement rotates the ball valve component 204 to redirect fluid flow. A cap or spacer 218 can also be used to connect the wax element 202 to the plunger 208.

In the first linear position, the ball valve component 204 directs coolant from the engine 108 to the radiator 110 via the second conduit 104b. In the second (bypass) position, the ball valve component 204 directs coolant back to the engine 108 via the bypass conduit 112. This dual-position mechanism ensures that coolant flows to the radiator when needed or bypasses it when the engine is warming up.

Initially, coolant flows through the bypass conduit 112 to help the engine 108 reach operating temperature faster. Once the coolant temperature reaches a predefined level (corresponding to the melting point of the wax), the valve closes the bypass and opens the radiator conduit to regulate the coolant temperature by allowing cooler fluid to enter the engine 108.

As the wax element 202 expands with increasing temperature, the plunger 208 moves upward, causing the drive pin 206 to rotate the ball valve component 204. This rotation aligns the ball valve's passageway with the fluid flow path, enabling fluid to pass through.

When the temperature drops and the wax contracts, the plunger 208 moves downward, and the ball valve component 204 rotates back to its original position, halting fluid flow. This back-and-forth movement provides precise control over the valve.

While this thermostatic valve assembly 102 is described in the context of an internal combustion engine cooling system, it can be used in a wide range of applications requiring temperature-controlled fluid regulation, such as transmission cooling systems, heating systems, and industrial fluid control.

The interaction between the plunger 208 and the drive pin 206 enables precise rotational control of the ball valve component 204, ensuring accurate fluid regulation. This system minimizes wear, enhancing the valve's durability and reliability. The wax element's 202 responsiveness to temperature changes ensures rapid and efficient adjustments to fluid flow.

The plunger 208 may feature different profiles for the drive opening 212 to engage the drive pin 206, allowing for fine-tuned control of the ball valve component's 204 movement, ensuring precise fluid regulation in response to temperature changes.

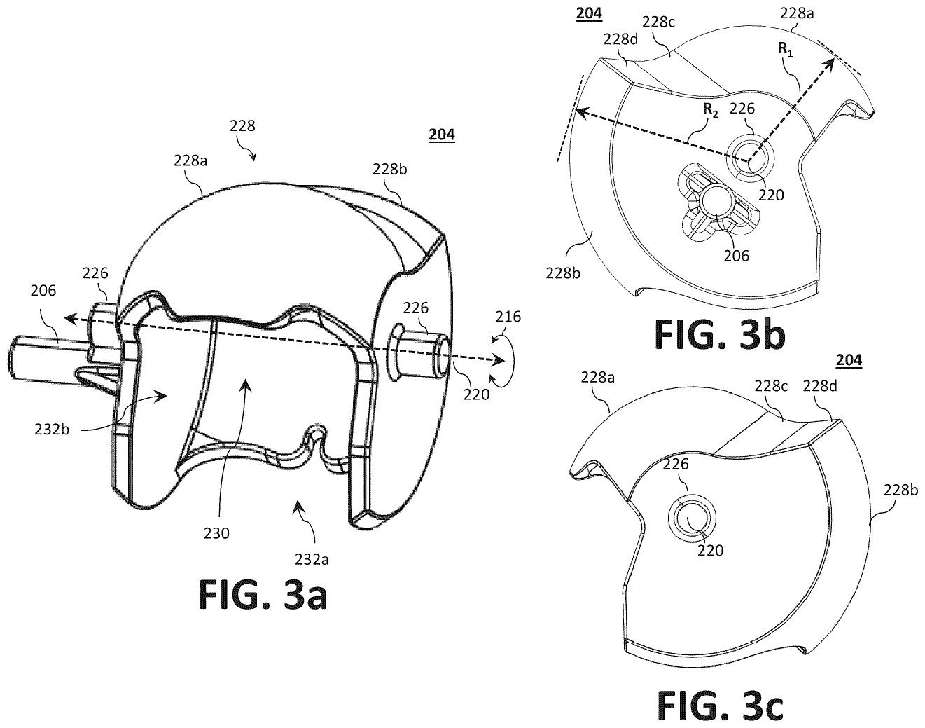

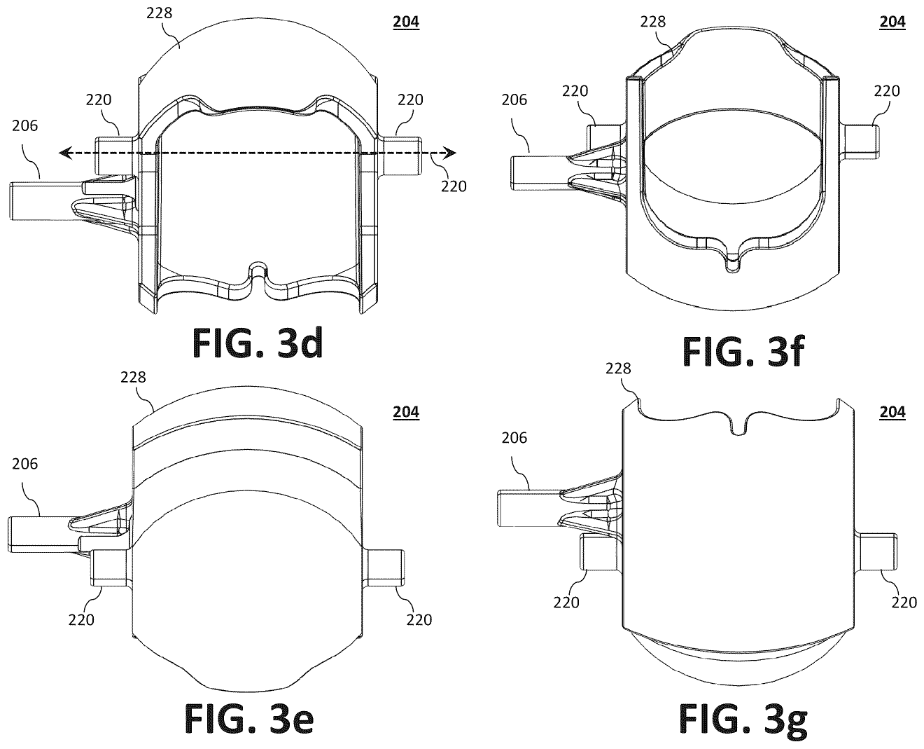

FIG. 3a provides a perspective view of the ball valve component 204, while FIGS. 3b and 3c offer side elevation views. FIGS. 3d and 3e show front and rear elevation views, and FIGS. 3f and 3g show top and bottom plan views, respectively.

The thermostatic valve assembly 102 comprises a ball valve component 204, which is rotatably mounted in the valve body 114 via a pair of pivot shafts 226. Each of the pivot shafts 226 is illustrated as a generally cylindrical pin extending outwardly from the body portion 228. The pair of pivot shafts 226 coincide and/or are concentric with the axis 220. The ball valve component 204 is configured to rotate about the axis 220 to control and redirect fluid flow between various ports in the cooling system as indicated by arrow 222, including bypass and radiator conduits.

The ball valve component 204 features a body portion 228, which defines a cavity 230. The cavity 230 is configured to direct fluid flow between the first opening 232a and the second opening 232b, as indicated by arrow 222. The illustrated cavity 230 enables fluid redirection at an angle of about 90 degrees, providing enhanced flow control capabilities. The ball valve component 204 rotates about an axis 220 within the valve body 114 around an axis 220, as indicated by arrow 216.

A drive pin 206 is located on the surface of the ball valve component 204 (e.g., the body portion 228) and engages the plunger 208 through a drive opening 212. As illustrated, the drive pin 206 is offset relative the pivot shafts 226. The plunger 208 is connected to a wax element 202, which expands and contracts in response to temperature changes, providing linear motion to the plunger 208. The linear motion of the plunger 208 is converted into rotational movement of the ball valve component 204, enabling the ball valve to align or block fluid flow paths within the valve body 114.

The ball valve component 204 is generally spherical or partially spherical and includes passageways 232a and 232b that align with the fluid paths in the valve body 114 when the valve is in the open position. By rotating, the ball valve component 204 can either open or close the valve, controlling the flow of fluid between the inlet, radiator, and bypass ports.

As part of the thermostatic valve assembly 102, the ball valve component 204 is positioned between a pair of seals 224a and 224b, also referred to as the first seal 224a and the second seal 224b. These seals may be made from materials such as polytetrafluoroethylene (PTFE), known for their durability and resistance to wear. Each of the first seal 224a and the second seal 224b may be generally planar and annular to allow fluid flow therethrough.

The disclosure addresses an issue in existing systems: a controlled gap (e.g., 1 mm or less, such as 0.2 mm to 0.4 mm, or about 0.3 mm) is often used in the bypass seal, allowing debris to collect and coolant to leak through the gap when the valve is in the bypass-closed position. This coolant flow through the gap reduces the radiator's efficiency in cooling the internal combustion engine, leading to a decrease in the overall efficiency of the engine cooling system.

To address these inefficiencies and maintain the existing size of the thermostatic valve assembly 102, the body portion 228 of the ball valve component 204 employs a dual-radius design. This design allows sufficient space to incorporate both the first seal 224a and second seal 224b without increasing the valve assembly's overall dimensions.

Referring to FIGS. 3a and 3b, the body portion 228 defines a first spherical portion 228a with a first radius R1, representing the distance between axis 220 and the exterior surface of the first spherical portion 228a. The body portion 228 also includes a second spherical portion 228b with a second radius R2, representing the distance between axis 220 and the exterior surface of the second spherical portion 228b. In this example, the second radius R2 is greater than the second radius R1. In some examples, each of the first spherical portion 228a and the second spherical portion 228b can be described as a spherical segment.

In some examples, the body portion defines a transition portion between the first spherical portion 228a and the second spherical portion 228b. In the illustrated example, the transition portion comprises a sloped region 228c and a planar region 228d. For example, the transition portion comprises a sloped region 228c adjacent to a planar region 228d. In other examples, the transition portion may comprise either a sloped region 228c or a planar region 228d.

The dual-radius design provides additional room to incorporate the seals 224a and 224b, which match more closely with the bypass flow port's interior diameter. This configuration reduces pressure drops and improves the efficiency of the internal combustion engine cooling system.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A thermostatic valve assembly comprising:
a valve body having a chamber; and
a thermostatic assembly comprising a wax element, a ball valve component having a drive pin, and a plunger having a drive opening that is configured to receive the drive pin,
wherein the plunger is connected to the wax element and slideably secured within the chamber and configured to move between a first linear position and a second linear position,
wherein the ball valve component is rotatably secured within the chamber and configured to move between a first rotational position about an axis when the plunger is in the first linear position and a second rotational position when the plunger is in the second linear position, and
wherein the ball valve component comprises a body portion with a cavity configured to direct fluid flow, the body portion defining a first spherical portion having a first radius defined between the axis and an exterior surface of the first spherical portion, and a second spherical portion having a second radius defined between the axis and an exterior surface of the second spherical portion.

2. The thermostatic valve assembly of claim 1, wherein the second radius is greater than the first radius.

3. The thermostatic valve assembly of claim 1, wherein the ball valve component is rotatably mounted relative to the valve body via a pair of pivot shafts.

4. The thermostatic valve assembly of claim 1, wherein the ball valve component is rotatably secured within the chamber between a first seal and a second seal.

5. The thermostatic valve assembly of claim 4, wherein each of the first seal and the second seal is a polytetrafluoroethylene (PTFE) seal.

6. The thermostatic valve assembly of claim 1, wherein the body portion defines a transition portion between the first spherical portion and the second spherical portion.

7. The thermostatic valve assembly of claim 6, wherein the transition portion comprises a sloped region or a planar region.

8. The thermostatic valve assembly of claim 6, wherein the transition portion comprises a sloped region and a planar region.

9. A thermostatic assembly for use in a thermostatic valve assembly having a chamber, the thermostatic assembly comprising:
a wax element;
a ball valve component having a drive pin; and
a plunger having a drive opening that is configured to receive the drive pin,
wherein the plunger is connected to the wax element and slideably secured within the chamber and configured to move between a first linear position and a second linear position,
wherein the ball valve component is rotatably secured within the chamber about an axis and configured to move between a first rotational position when the plunger is in the first linear position and a second rotational position when the plunger is in the second linear position, and
wherein the ball valve component comprises a body portion including a first spherical portion having a first radius defined between the axis and an exterior surface of the first spherical portion, and a second spherical portion having a second radius defined between the axis and an exterior surface of the second spherical portion.

10. The thermostatic assembly of claim 9, wherein the second radius is greater than the first radius.

11. The thermostatic assembly of claim 9, wherein the ball valve component is rotatably mounted via a pair of pivot shafts.

12. The thermostatic assembly of claim 9, wherein the body portion defines a transition portion between the first spherical portion and the second spherical portion.

13. The thermostatic assembly of claim 12, wherein the transition portion comprises a sloped region and a planar region.

14. A ball valve component for use in a thermostatic assembly having a wax element and a plunger having a drive opening, the ball valve component comprising:
a drive pin configured to engage the drive opening;
a pair of pivot shafts; and
a body portion configured to rotate about an axis via a pair of pivot shafts to direct fluid flow,
wherein the body portion comprises a first spherical portion having a first radius defined between the axis and an exterior surface of the first spherical portion, and a second spherical portion having a second radius defined between the axis and an exterior surface of the second spherical portion.

15. The ball valve component of claim 14, wherein the second radius is greater than the first radius.

16. The ball valve component of claim 14, wherein the ball valve component is rotatably mounted in a valve body of the thermostatic assembly via a pair of pivot shafts.

17. The ball valve component of claim 14, wherein the body portion defines a transition portion between the first spherical portion and the second spherical portion.

18. The ball valve component of claim 17, wherein the transition portion comprises a sloped region.

19. The ball valve component of claim 17, wherein the transition portion comprises a planar region.

20. The ball valve component of claim 17, wherein the transition portion comprises a sloped region and a planar region.
